(19) United States
(12) Patent Application Publication
(10) Pub. No.: US 2026/0317911 A1
(43) Pub. Date: Oct. 15, 2026

(54) ULTRASOUND DEGREASING EQUIPMENT

(71) Applicant: ArcelorMittal, Luxembourg (LU)

(72) Inventors: Pierre RICHET, Metz (FR); Florent SPONEM, Vigy (FR)

(21) Appl. No.: 19/463,830

(22) Filed: Jan. 29, 2026

Related U.S. Application Data
(63) Continuation of application No. 17/289,333, filed on Nov. 5, 2019, now abandoned.

(30) Foreign Application Priority Data
Nov. 6, 2018 (WO) PCT/IB2018/058711

(51) Int. Cl. C23G 1/14; B08B 3/12; C23G 3/02

(52) U.S. Cl. CPC C23G 1/14; B08B 3/123; C23G 3/021; C23G 3/025

(57) ABSTRACT

A continuous cleaning installation 1 of a passing strip S includes a tank 2, an aqueous solution 3 inside the tank 2. It also includes at least a roller 4 immerged in the aqueous solution 3, at least an ultrasound emitter 5, a feed for feeding 6 an aqueous solution and emptying 7 the tank. Moreover, it also includes an aqueous solution level estimator for estimating 8 the aqueous solution level, a distance calculator for calculating 9 for each ultrasound emitter 5 its distance to the aqueous solution level and a power controller for controlling the power 10 of the at least one ultrasound emitter 5 and at least an impermeable closable opening 11 on at least a lateral side of the tank through which the at least one ultrasound emitter 5 can pass.

This is a Continuation of U.S. patent application Ser. No. 17/289,333, filed on Apr. 28, 2021, published as US 2022/0008961 A1, which is a National Phase Application of PCT/IB2019/059493, filed on Nov. 5, 2019, which claims priority to International Patent Application PCT/IB2018/058711, filed on Nov. 6, 2018.

The present invention relates to an equipment for continuously cleaning a strip in a tank with ultrasound emitting means. Such an invention eases the global management of said cleaning tank.

### BACKGROUND

In the metallurgical field, producing strip having a high surface quality is of a major importance. During the rolling step, iron, metallic particles, dirt and grease adhere to the metal strip. Such adhesions engender a degradation of the strip surface quality post-coating because they will be entrapped under the coating and thus the surface will not be smooth. In order to avoid such drawbacks, the strip is cleaned before the coating step. Generally, it occurs after the rolling operation and before the annealing or the coating. To do so, most of the cleaning lines uses an electrolytic process among their cleaning operations. However, such a technique presents a high safety risk due to the H₂ accumulation leading to safety hazards such as fire. Consequently, cleaning lines using ultrasound have been developed to replace the electrolytic process. Naturally, new problems have arisen, especially concerning the management of the ultrasound emitting means. Usually, transducers converting oscillating electrical energy into mechanical energy are used, creating the ultrasound. Despite those emerging problems, such lines are interesting because they are safer, create fewer by-products and have a lower electrical consumption, being thus more eco-friendly.

Ultrasound cleaning works thanks to the propagation of an ultrasound wave (or more generally an acoustic wave) through an aqueous solution which induces local variations of the aqueous solution pressure. When the negative pressure is low enough (lower than the aqueous solution vapour pressure), the aqueous solution cohesive forces break down, and gas bubbles (also called cavitation bubbles) are formed. These bubbles are then submitted to pressure variations (due to acoustic wave propagation), which cause them to expand and contract successively until they collapse. Ultrasonic waves induce a thermal effect, but also a mechanical effect due to cavitation. Indeed, two phenomena occur when cavitation bubbles break down:
shock waves due to the violent compression of the gas present in the bubble,
micro-jets: near a solid surface, the bubble implosion becomes dissymmetrical and the resulting shock wave produces aqueous solution micro-jets that are directed toward the solid surface. The impacts of the micro-jets on the solid surface are energy-rich, and this mechanical effect can be used in galvanization for the cleaning of the strip surface after cold rolling.

Patent KR 2005 006 3145 discloses an apparatus cleaning a steel sheet. Said steel sheet is passed through a tank filled with an alkaline solution in which ultrasound emitting means are arranged inside boxes placed on each side of the passing sheet.

### SUMMARY OF THE INVENTION

However, by using the above method and its equipment, two major drawbacks appear. Firstly, the intensity of the ultrasounds emitted by ultrasound emitting means placed inside the housing is lowered when the ultrasounds pass through the housing wall. Secondly, the maintenance is time-consuming because the replacement of a box containing the ultrasound emitting means requires the removal of the several pieces, the use of a scaffolding and also raises safety concerns.

It is an object of the present invention to provide a solution solving the aforementioned problems.

The present invention provides an equipment (1) for the continuous cleaning of a moving strip (S) comprising:
a tank (2) containing an aqueous solution (3),
at least a roll (4) for guiding said strip into said tank (2),
at least an ultrasound emitting mean (5),
means (aqueous solution feed 6) for feeding said aqueous solution (3) inside said tank (2),
means (tank emptier 7) for emptying the tank (2),
means (8) for estimating the aqueous solution level in said tank (2),
means for calculating (distance calculator 9), for each ultrasound emitting mean (5) its distance to the aqueous solution level,
means for controlling the power (power controller 10) of the at least one ultrasound emitting mean (5),
at least an impermeable closable opening (11) on at least a lateral side of said tank (2) through which the at least one ultrasound emitting mean (5) can be introduced,
a wire (W) connecting said means for controlling the power (10) of the at least one ultrasound emitting mean (5) and the at least one ultrasound emitting mean (5).

Another object of the present invention is to provide a method for cleaning of a moving metal strip using the equipment, and to provide a method for replacing an ultrasound emitter in the equipment.

Other characteristics and advantages of the invention will become apparent from the following detailed description of the invention.

### BRIEF DESCRIPTION OF THE DRAWINGS

To illustrate the invention, various embodiments and trials of non-limiting examples will be described, particularly with reference to the following figure:

FIGS. 1A and 1B exhibit a lateral and a front view of an embodiment of a tank with ultrasound emitting means.

FIGS. 2A and 2B exhibit a lateral and a top view of a second embodiment of a tank with ultrasound emitting means.

FIGS. 3A and 3B show two embodiments of ultrasound emitting means.

FIGS. 4A and 4B exhibit two embodiments of supporting means.

FIG. 5 shows a preferred arrangement of the ultrasound emitting means and the associated waves.

FIG. 6 shows the effect of the type of ultrasound emitting means on the cleaning efficiency.

### DETAILED DESCRIPTION

The invention relates to an equipment 1 for the continuous cleaning of a moving strip S comprising:
a tank 2 containing an aqueous solution 3,
at least a roll 4 for guiding said strip into said tank 2,
at least an ultrasound emitting mean 5,
means 6 for feeding said aqueous solution 3 inside said tank 2,
means 7 for emptying the tank 2,
means 8 for estimating the aqueous solution level in said tank 2,
means for calculating 9, for each ultrasound emitting mean 5 its distance to the aqueous solution level,
means for controlling the power 10 of the at least one ultrasound emitting mean 5,

at least an impermeable closable opening 11 on at least a lateral side of said tank 2 through which the at least one ultrasound emitting mean 5 can be introduced,

a wire W connecting said means for controlling the power 10 of the at least one ultrasound emitting mean 5 and the at least one ultrasound emitting mean 5.

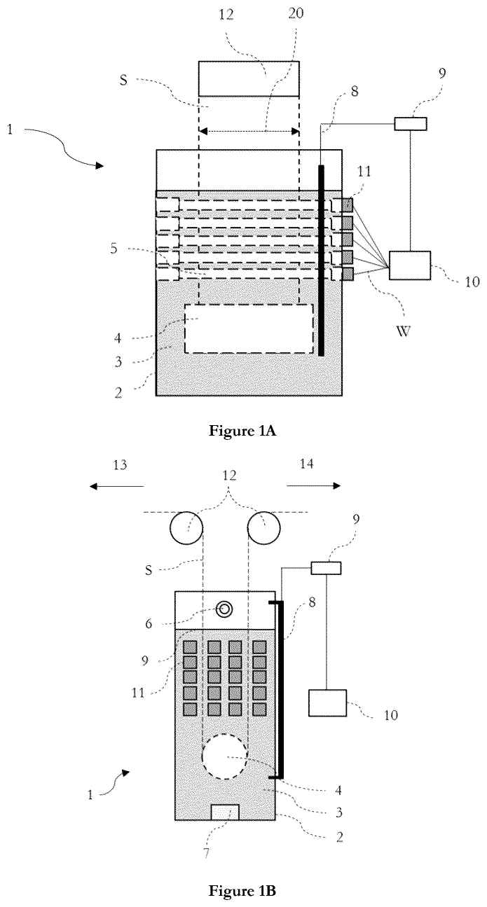

FIG. 1A is a lateral view and FIG. 1B is a front view of the continuous cleaning installation. As illustrated in FIGS. 1A and 1B, the continuous cleaning installation 1 of a moving strip S comprises a tank 2, an aqueous solution 3 inside said tank. It also comprises at least a roll 4 immerged in said aqueous solution 3, at least an ultrasound emitting mean 5, means for feeding 6 an aqueous solution and emptying 7 the tank. Moreover, it also comprises means for estimating 8 the aqueous solution level, means for calculating 9 for each ultrasound emitting mean its distance to the aqueous solution level and means, means for controlling the power 10 of the at least one ultrasound emitting mean 5 and at least an impermeable closable opening 11 on at least a lateral side of said tank through which the at least one ultrasound emitting mean can be introduced, said means for controlling the power and the at least one ultrasound emitting mean are connected through the at least one closable opening by a wire W.

As illustrated in FIG. 1A, the aqueous solution feed 6 is preferentially situated in the upper portion of the tank or at the top of the tank allowing a better filling of the tank, so the cleaning time and the distance passed by the strip through the aqueous solution is increased. The tank emptier 7 is placed in the lower portion of the tank and preferentially at its bottom in order to empty the tank as much as possible, such means can be pipes and valves connected to a dump, a recycling or a regenerating process.

The at least one roller 4 is preferentially at the bottom of the tank but above the emptying means 7, such an arrangement increases the distance travelled by the strip S through the aqueous solution 3 and the cleaning time thus improving the cleaning.

The aqueous solution 3 is introduced into the tank by the feeding means or aqueous solution feed 6 such as pipes and valves, preferentially connected to another tank filled with the solution.

As illustrated in FIG. 1A, the cleaning installation 1 preferably comprises at least two external rollers 12 placed above said tank 2, at least one on each side of the tank e.g.: one on the upstream side 13, the other one on the downstream side 14 of the ultrasonic cleaning installation. The rollers 12 and 4 have preferentially the same orientation, e.g. their rotation axes are parallel. The rollers positioning should preferably allow the strip S to pass through the aqueous solution 3 without being twisted.

The aqueous solution level estimator 8 can be a differential pressure captor or any means used in a hydrostatic method. The aqueous solution level estimator 8 can also be composed of several aqueous solution level indicators, disposed along the bath height indicating the presence or not of an aqueous solution permitting to estimate the aqueous solution level between two indicators. Such level indicators can be vibrating level switches.

The at least one ultrasound emitting mean 5 is placed inside said tank 2 preferably under the feeding means 6 and preferably above the roller 4.

In the prior art, it seems that it is not possible to easily and quickly remove an ultrasound emitting mean from the tank. The equipment according to the invention enables a quicker and easier removal of an ultrasound emitting mean for several reasons. Firstly, no scaffolding is required which reduces the replacement time and makes it safer for the workers. Secondly, the tank is not totally emptied but the bath level is set under the ultrasound emitting mean to be replaced, so the filling time after the operation is shorter.

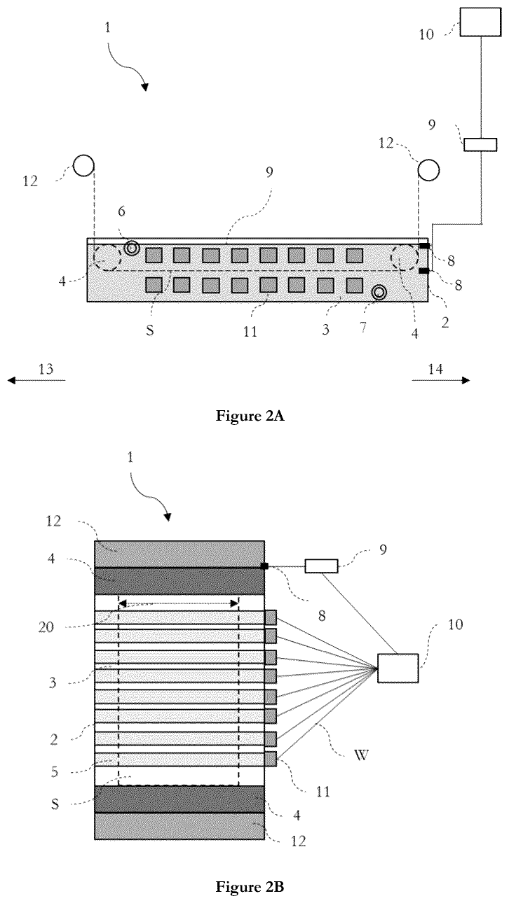

FIGS. 2A and 2B exhibit the lateral and top view of a second preferred embodiment of the continuous cleaning installation in which the strip S is majorly moved horizontally through the aqueous solution compared to the FIGS. 1A and 1B where the strip S is majorly passed vertically.

Preferably, said at least an ultrasound emitting mean 5 is immerged in the aqueous solution 3. It permits to enhance the efficiency of the cleaning.

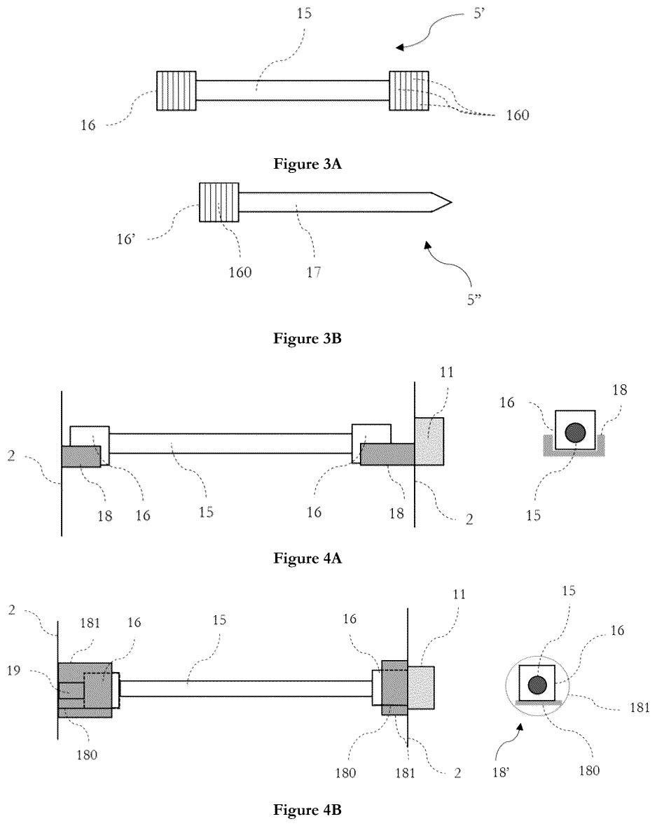

Preferably, as illustrated in FIGS. 3A and 3B, said at least one ultrasound emitting mean is a resonator rod 15 vibrating thanks to at least one piezo-electric transducer 160. Such ultrasound emitting means can be a push-pull transducer 5′. Such ultrasound emitting means allow an omnidirectional emission of ultrasound. Consequently, it improves the cleaning efficiency compared to boxes containing ultrasound emitting means. As illustrated in FIG. 3A, those ultrasound emitting means, the push-pull transducers, have generally a central resonator rod 15 encompassed by two ultrasonic driverheads 16 generally containing the at least one piezo-electric transducer 160. Said driverhead generally comprises several piezoelectric transducers. Even more preferably, they work at a frequency of 25 kHz and generates 2 kW. However, the ultrasound emitting means 5″ can also be comprised of only one driverhead 16′ and a resonator rod having a pointy end 17, as illustrated in FIG. 3B.

Several tests have been done to demonstrate the improved efficiency of a cleaning tank equipped with transducers, such as push-pull transducers, compared to one equipped with submersible boxes. In those tests, the cleanliness of a strip sample has been measured before and after a cleaning step. In those experiments, a strip is immersed during 24 sec in a box containing a cleaning bath, having 10 g·L⁻¹ of NaOH, at 65° C. and either a set of two push-pull piezo transducers having a power of 2 kW or a submersible box having a power of 2 kW. It is assumed that an immersion time of 24 seconds in the experiment conditions corresponds to a direct exposition time of about 6 seconds because a strip portion is faced by an ultrasound emitter means only during a quarter of the experiment time due to its displacement through the aqueous solution.

The cleaning efficiency, as noted in the following table, is: “the estimated cleanliness before the cleaning step” divided by “the estimated cleanliness after the cleaning step”. To estimate the cleanliness, a 3M 595 Scotch™ adhesive is pressed on a strip surface in order to stick the iron fines and the oil onto the adhesive. Then the reflectance of the scotch is measured by a reflectometer. This reflectance is linked to the density of iron fines per square meter. The more iron fines have adhered to the adhesive, the lower will be its reflectance. Consequently, the higher is the adhesive reflectance, the cleaner is the strip. The following table contains the main parameters of the experiment. In FIG. 6, the cleaning efficiency is, for various strip speed, plotted for both types of ultrasound emitting means: the push-pull tubes and the submersible boxes.

| | | | Bath | | Immersion | Cleanliness | Cleanliness | Cleaning |
|---|---|---|---|---|---|---|---|---|
| | Frequency | Power | temperature | Strip speed | time | before | after | efficiency |
| Type | (kHz) | (kW) | (° C.) | (m · min⁻¹) | (sec) | cleaning | cleaning | (%) |
| Box | 25 | 2 | 65 | 50 | 24 | 9.50 | 7.00 | 26 |
| PP | 25 | 2 | 65 | 50 | 24 | 9.04 | 4.15 | 54 |
| Box | 25 | 2 | 63 | 100 | 24 | 10.55 | 7.62 | 28 |
| PP | 25 | 2 | 62 | 100 | 24 | 11.99 | 6.02 | 50 |
| Box | 25 | 2 | 64 | 150 | 24 | 10.00 | 8.09 | 19 |
| PP | 25 | 2 | 66 | 150 | 24 | 10.95 | 6.53 | 40 |
| Box | 40 | 2 | 67 | 100 | 24 | 8.51 | 6.61 | 22 |
| PP | 40 | 2 | 67 | 100 | 24 | 10.70 | 7.30 | 32 |

Preferably, as illustrated in FIG. 4A, the driverheads 16 are supported by supporting pieces 18 arranged on opposite sides of the tank 2, said supporting pieces being positioned such that the resonator rod 15, the driverhead 16, the impermeable closable opening 11 and the supporting pieces 18 are aligned. Said supporting pieces 18 can be formed as an “U” shape, as illustrated in FIG. 4A, wherein the driverhead 16 is set on the horizontal part of the “U” shape piece, ensuring a good vertical positioning, and the two vertical parts of the “U” shape pieces surround the driverhead 16, ensuring a good horizontal positioning of the driverhead 16. As illustrated in FIG. 4B, the supporting pieces 18′ can also be made of a tubular part 180 surrounding a flat horizontal part 181 on which the driverhead 16 is positioned. Such arrangements ease a good positioning of the ultrasound emitting mean 5′. To precisely position the ultrasound emitting means, at least a stop 19 is arranged on the supporting means between a tank wall and an extremity of the ultrasound emitting mean, e.g. a driverhead, as illustrated on FIG. 4B.

Preferably, as it can be seen in FIG. 1, said resonator rod 15 has its length parallel to the strip width 20. Even more preferentially, the rod is positioned parallel to the strip width 20 in a way that it covers the whole strip width. Such an arrangement should improve the cleaning efficiency and the cleaning homogeneity along the strip width. When the tank comprises at least two resonator rods having a resonator rod length smaller than the strip width, the resonator rods are shifted in order to cover the whole strip width.

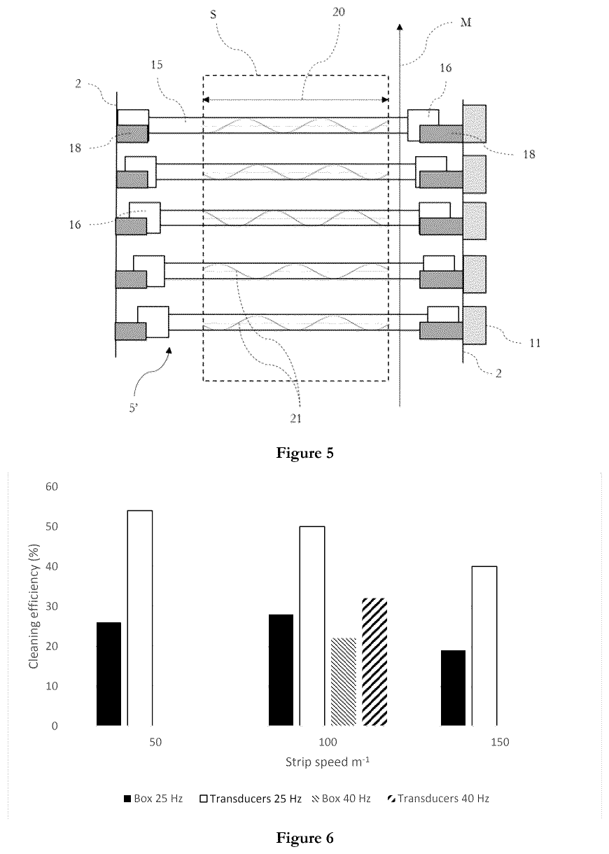

Preferably, as illustrated in FIG. 5, the tank 2 contains at least two similar tubular piezo-electric ultrasound emitting means, for example push-pull transducers 19, the ones being on the same side of the strip being shifted one from another by a distance corresponding to (0.5) times the wavelength produced by the push-pull transducers. When the number of ultrasound emitting means is equal to m, each of them can be further shifted by a similar distance, (1/m) times the wavelength towards its neighbours.

For example, if six ultrasound emitters working at a frequency of 25 kHz are used in an environment comparable to water, the wave speed, which depends on numerous factors (e.g.: the temperature and the pressure) is approximately of 1500 m·s⁻¹. The wavelength is equal to the wave speed divided by the wave frequency so in this case, 1 500/25 000=0.06, the wavelength is approximately of 6 cm. In the case where the ultrasound emitting means produce ultrasound with a wavelength of 6 cm, they should be laterally shifted of, (⅙)×6=1 cm one from another.

As it can be seen in FIG. 5, such an arrangement prevents having two nodes 21 aligned in the strip moving direction. Such a shift allows improving the cleaning homogeneity, as it ensures that all points of the strip are being exposed to at least one ultrasound wave.

Preferably, said resonator rod 15 and the strip S are spaced by a distance comprised between 40 mm and 250 mm. Such spacing enables to efficiently use the ultrasound emitting mean. Such spacing distance improves the installation 1 because if the spacing if less than 40 mm, the ultrasound emitting mean will eventually be broken by the strip S due for example strip bending or strip flatness irregularities. But if the spacing is bigger than 200 mm then the efficiency of the ultrasound emitting mean cleaning power seems to be severely reduced.

Preferably, said at least closable opening 11 is separable from the tank 2 and attached to the ultrasound emitting mean 5. Such an arrangement eases the removal of the ultrasound emitting mean.

Preferably, the strip S to be cleaned has two opposite surfaces and the equipment according to the invention comprises preferably at least one ultrasound emitting mean 5 facing each of said surface. Even though an ultrasound emitting mean placed on one side of a strip cleans both surfaces, having ultrasound emitting means facing each surface increases the cleaning quality.

Consequently, in an installation similar to the one represented in FIGS. 1A and 1B, at least one ultrasound emitting mean 5 is positioned between a tank wall and the strip S and at least one ultrasound emitting mean is positioned between a portion of the strip going down and a portion of the strip going up.

Consequently, in an installation similar to the one represented in FIGS. 2A and 2B, at least one ultrasound emitting device is placed above and at least one other is placed under the strip. Preferably, when at least three ultrasonic devices are used, at least one is positioned above the strip and at least one is positioned under the strip, the ones positioned above and under the strip form two rows R1 and R2, as illustrated in FIG. 2A.

Preferably, said equipment has a power density between 5 Watt per litre and 25 Watt per litre. Even more preferentially, the power per litre is between 10 and 20 W·1⁻¹. Using a power density in this range seems to be the best compromise between a sufficient cleaning and energy saving, it allows a good and sufficient cleaning of the strip and avoid energy waste.

The equipment accord to the invention can be used for cleaning any strip that is compatible with it. Preferably, said strip is a metal strip. More preferably, said metal strip is a steel strip.

The invention also relates to a method for the continuous cleaning of a moving strip S using the equipment according to the present invention, wherein said strip is a metal strip.

Preferably, said aqueous solution contains between 10 grams per litre and 40 grams per litre of alkali product. Apparently, an alkali product concentration in this range improves the cleaning and efficiently uses the alkali product. Other solutions such as acidic or neutral solutions can be used, the solution selection depends on the substrates and the pollutants.

Preferably, said aqueous solution is kept at a temperature between 30° C. and 80° C. Apparently, higher is the cleaning solution temperature, better is the cleaning efficiency of the process but shorter is the ultrasound emitting mean lifespan. This range seems to be the best compromise between cleaning efficiency and the ultrasound emitting mean lifespan.

The invention also relates to a method for replacing an ultrasound emitting mean 5 of an equipment according to the present invention, comprising:
lowering the aqueous solution level below the level of the impermeable closable opening 11 of the ultrasound emitting mean 5 to be replaced, at least to a distance equal to a determined value using said means 8 for estimating the aqueous solution level in said tank 2, said means for calculating 9 and said means 7 for emptying said tank,
removing said ultrasound emitting mean to be replaced 5 through the impermeable closable opening 11,
installing another ultrasound emitting mean 5 through the impermeable closable opening 11.

The process management system estimates for impermeable closable opening 11 its distance to the aqueous solution level. This estimation is made by the means for calculating 9 based on the impermeable closable opening position, i.e.: at what height they are positioned, and the estimation of the aqueous solution level thanks to the means for estimating the aqueous solution level 8. The means for calculating 9 calculates the distance between an impermeable closable opening position and the estimated level of the aqueous solution.

For safety reasons, the aqueous solution level should be set below an impermeable closable opening of the ultrasound emitting means to be removed because when the closable opening is opened, it prevents the solution 3 to flow out of the bath 2. Consequently, a determined value defines the minimal distance between an impermeable closable opening of an ultrasonic emitting mean to be replaced and the aqueous solution level required to safely replace said ultrasound emitting mean.

In the case where means for estimating the aqueous solution level are composed of at least several aqueous solution indicators, such as vibrating level switches, the aqueous solution level indicators are preferentially placed below each impermeable closable opening 11 at the predetermined distance.

When using an equipment according to the prior art, the procedure to replace an ultrasound emitting means is the following:
the line is stopped,
the bath is totally emptied,
the immerged roll is dismounted,
the atmosphere of the tank is analysed,
the tank walls are cleaned,
a scaffolding is mounted,
the ultrasound emitting mean is dismounted,
the wire connecting the means for controlling the power of the ultrasound emitting means and the ultrasound emitting mean is disconnected from the ultrasound emitting mean,
the wire connecting the means for controlling the power of the ultrasound emitting means and the ultrasound emitting mean is connected to a new ultrasound emitting mean,
a new one is mounted,
the scaffolding is dismounted,
the immerged roll is mounted,
the bath is filled,
the line is restarted.

Whereas when the equipment according to the invention is used, the procedure is much shorter and simpler:
the line is stopped,
the bath level is set under the ultrasound emitting mean to be replaced,
the ultrasound emitting mean is dismounted through the closable opening in the wall,
the wire connecting the means for controlling the power of the ultrasound emitting means and the ultrasound emitting mean is disconnected from the ultrasound emitting mean,
the wire connecting the means for controlling the power of the ultrasound emitting means and the ultrasound emitting mean is connected to a new ultrasound emitting mean,
the new one is mounted through the wall,
the bath is filled,
the line is restarted.

As it can be observed, no scaffolding is used with the present invention so the replacement duration is reduced by 8 hours, as it takes 1 hour instead of 9 hours.

The present invention is applicable to every process in which a strip is cleaned by passing it through an aqueous solution filled tank comprising ultrasound emitting means.

The invention has been described above as to the embodiment which is supposed to be practical as well as preferable at present. However, it should be understood that the invention is not limited to the embodiment disclosed in the specification and can be appropriately modified within the range that does not depart from the gist or spirit of the invention, which can be read from the appended claims and the overall specification, and a manufacturing method of a hot-rolled steel sheet and a manufacturing apparatus of a hot-rolled steel sheet with such modifications are also encompassed within the technical range of the invention.

What is claimed is:

1. An equipment for continuous cleaning of a moving metal strip comprising:
a tank containing an aqueous solution;
at least one roll for guiding the metal strip into the tank, the at least one roll fully immersed in the aqueous solution;
at least one ultrasound emitter positioned in the tank between a tank wall and the moving strip;
an aqueous solution feed pipe for feeding the aqueous solution inside the tank;
a tank emptier pipe for emptying the tank;
an aqueous solution level estimator for estimating an aqueous solution level in the tank;
a distance calculator for calculating for each ultrasound emitter a distance to the aqueous solution level;
a power controller for controlling a power of the at least one ultrasound emitter;
at least one impermeable closable opening on at least one lateral side of the tank, the at least one impermeable closable opening separable from the tank and positioned in the tank such that the at least one ultrasound emitter is introducible through the at least one impermeable closable opening while the at least one roll remains immersed in the aqueous solution; and
a wire connecting the power controller and the at least one ultrasound emitter.

2. The equipment as recited in claim 1, wherein the at least one ultrasound emitter is a push-pull transducer.

3. The equipment as recited in claim 2, wherein the push-pull transducer comprises a central resonator rod encompassed by two ultrasonic driverheads containing at least one piezo-electric transducer.

4. The equipment as recited in claim 3, wherein the driverheads are supported by supporting pieces arranged on opposite sides of the tank, the supporting pieces being positioned such that the resonator rod, the driverheads, the impermeable closable opening and the supporting pieces are aligned.

5. The equipment as recited in claim 4, wherein the supporting pieces have a horizontal part and two vertical parts, the driverheads are set on the horizontal part, and the two vertical parts surround the driverheads.

6. The equipment as recited in claim 4, wherein the supporting pieces comprise a tubular part surrounding a flat horizontal part on which the driverheads are positioned.

7. The equipment as recited in claim 3, wherein the central resonator rod has a length parallel to a strip width of the moving strip.

8. The equipment as recited in claim 7, wherein the central resonator rod and the moving strip are spaced by a distance comprised between 40 mm and 250 mm.

9. The equipment as recited in claim 7, wherein the central resonator rod is positioned in a way that it covers the whole strip width.

10. The equipment as recited in claim 7, wherein the resonator rod has a resonator rod length smaller than the strip width.

11. The equipment as recited in claim 2, wherein the tank contains at least two push-pull transducers on the same side of the strip shifted one from another by a distance corresponding to 0.5 times the wavelength produced by the push-pull transducers.

12. The equipment as recited in claim 1, wherein the at least one impermeable closable opening is attached to the at least one ultrasound emitter.

13. The equipment as recited in claim 1, wherein the at least one ultrasound emitter is immerged into the aqueous solution.

14. The equipment as recited in claim 1, wherein the moving metal strip has two opposite surfaces and the equipment includes at least one ultrasound emitter facing each of the two opposite surfaces.

15. The equipment as recited in claim 1, wherein the equipment has a power capacity between 5 Watt per liter and 25 Watt per liter.

16. The equipment as recited in claim 1, wherein least one ultrasound emitter is placed above the moving metal strip and at least one ultrasound emitter is placed under the moving metal strip.

17. An equipment for continuous cleaning of a moving metal strip comprising:
a tank containing an aqueous solution;
at least one roll for guiding the metal strip into the tank, the at least one roll fully immersed in the aqueous solution;
at least one ultrasound emitter positioned in the tank between a tank wall and the moving strip;
an aqueous solution feed pipe for feeding the aqueous solution inside the tank;
a tank emptier pipe for emptying the tank;
an aqueous solution level estimator for estimating an aqueous solution level in the tank;
a distance calculator for calculating for each ultrasound emitter a distance to the aqueous solution level;
a power controller for controlling a power of the at least one ultrasound emitter;
at least one impermeable closable opening on at least one lateral side of the tank, the at least one impermeable closable opening positioned in the tank such that the at least one ultrasound emitter is introducible through the at least one impermeable closable opening while the at least one roll remains immersed in the aqueous solution; and
a wire connecting the power controller and the at least one ultrasound emitter;
wherein the at least one impermeable closable opening is separable from the tank and attached to the at least one ultrasound emitter,
the at least one ultrasound emitter is a push-pull transducer, and
the push-pull transducer is a push-pull tube.

18. The equipment as recited in claim 17, wherein the tank contains at least two push-pull transducers on the same side of the moving metal strip, and the at least two push-pull transducers are shifted one from another by a distance corresponding to 0.5 times the wavelength produced by the push-pull transducers.

19. The equipment as recited in claim 17, wherein the tank contains at least two push-pull transducers, the at least one of the at least two ultrasound emitters is placed above the moving meal strip and at least one of the at least two ultrasound emitters is placed under the moving metal strip.

20. The method as recited in claim 17, wherein the aqueous solution contains between 10 grams per liter and 40 grams per liter of alkali product.
